(19) United States
(12) Patent Application Publication
(10) Pub. No.: US 2006/0250117 A1
(43) Pub. Date: Nov. 9, 2006

(54) Power Factor Correction Analysis System and Method

(75) Inventor: David F. Rayburn, Georgetown, IN (US)

Correspondence Address: MIDDLETON & REUTLINGER, 2500 BROWN & WILLIAMSON TOWER, LOUISVILLE, KY, 40202, US

(73) Assignee: Titon Energy, Floyds Knobs, IN (US)

(21) Appl. No.: 11/382,191

(22) Filed: May 8, 2006

Related U.S. Application Data
(60) Provisional application No. 60/678,352, filed on May 6, 2005.

(51) Int. Cl. G05F 1/70; G05F 3/00

(52) U.S. Cl. 323/209

(57) ABSTRACT

An apparatus for determining the necessary capacitance required to correct power factor in an electrical power system comprises a plurality of capacitors having predetermined capacitances connected in series with a plurality of switching devices, said capacitances and switching devices connected between the line voltages of said power system to correct power factor. A means for determining power factor in said power system may include a power factor meter or a plurality of current transmitters and voltage probes used to provide data to a microcontroller to calculate power factor.

### CROSS REFERENCE TO RELATED APPLICATIONS

This application claims the benefit of and priority to U.S. Provisional Patent Application Ser. No. 60,678,352 filed May 6, 2005 and entitled “Power Factor Correction Apparatus”.

### BACKGROUND OF THE INVENTION

### Field of the Invention

The present invention relates generally to a system and method for correcting power factor in an electrical power distribution system and more specifically to an apparatus that is capable of calculating the appropriate capacitance required for power factor correction and thereby reducing attendant line losses in a power system from the point of installation of the device back to the power source, for example a pole transformer or the like in a residential application. The present invention further includes a system for supplying customers with power factor correction devices employing the requisite capacitance required to correct power factor to a value that is within a predetermined range of unity.

### SUMMARY OF THE INVENTION

The present invention provides a system for determining the necessary capacitance required to correct power factor caused by an inductive load in a modern power distribution network. In its various embodiments the present invention is capable of being used in conjunction with a plurality of types of electrical power distribution systems and is beneficial both to consumers or end users of electrical power as well as utilities and power generators.

When referring to electrical power systems, active power may be defined as the actual power performing useful work. It is typically measured in units of watts or kilowatts. An exemplary power measurement device is the conventional watt-hour meter often used in residential applications to measure the power being used by the residential consumer and the duration of that use. In many electrical power applications, the electrical loads being supplied with power include an inductive component that requires reactive power to be transmitted from the power source, along with the active power. Conventional electric motors often present large inductances to their power systems. Reactive power does no useful work. The sum of active power and reactive power is called apparent power.

Where there is a large inductance in a power circuit, apparent power is important because the power source must supply both reactive power current as well as active power current to the various electrical loads on the circuit. Since not all of that power is actually used to do work, the concept of power factor becomes important. Power factor is simply the ratio of active power to apparent power. As can be readily seen where power factor is 1 or unity the active power and apparent power are equal, and thus, little or no reactive power need be supplied to the load by the power source. Where power factor is below unity power lines, circuit breakers, and other devices used in power transmission systems must be sized larger than otherwise in order to handle the extra current required to supply the reactive power. Additionally, larger current through supply lines equates to more energy lost in transmission lines (line loss=I²R) (current², x resistance in the conductor) which can be quite large.

As is known in the art, power factor may be corrected by a properly sized capacitance connected electrically between, for example, line to line voltage in a conventional residential (240 VAC single phase) power system. Power factor correcting capacitors are rated in vars or kilovars (KVAR), which simply indicates how much leading reactive power a capacitor will supply. The leading reactive power of the capacitor cancels the lagging reactive power caused by a corresponding inductive load, and therefore decreases the amount of reactive power that must be supplied by the power source.

The present invention provides a system and method for quickly and easily determining the requisite capacitance for power factor correction in a given circuit application by providing a plurality of capacitors that may readily be switched into and out of a circuit by application of an automated switching system; or alternatively, by measuring power factor in the circuit and calculating the capacitance used to offset the inductance therein.

Additionally, the invention provides a system and method of evaluating the power factor of motors or other inductive loads at a facility, specifying the necessary corrective capacitance to correct for that power factor, and provide the facility with a comprehensive and tailored capacitive correction for each motor in an efficient and cost-effective manner.

Other objects, advantages and uses for the present invention will become apparent from the detailed description of the preferred embodiments taken in conjunction with the accompanying drawing Figures.

### BRIEF DESCRIPTION OF THE DRAWING FIGURES

FIG. 1 is a circuit diagram of a power factor correction device in accordance with one embodiment of the present invention.

FIG. 2 is a circuit diagram of a power factor correction device in accordance with one embodiment of the present invention.

FIG. 3 is a circuit diagram of a three phase power system and a power factor correction device in accordance with one embodiment of the present invention.

FIG. 4 is a block diagram of a power factor correction device in accordance with one embodiment of the present invention.

FIG. 5 is a block diagram of a system for providing corrective capacitance in accordance with one embodiment of the present invention.

FIG. 6 is a block diagram of a system for providing corrective capacitance in accordance with one embodiment of the present invention.

### DETAILED DESCRIPTION OF THE PREFERRED EMBODIMENT(S)

Referring now to the drawing Figures, and in accordance with a preferred constructed embodiment of the present invention, an apparatus 10 for determining the necessary capacitance for correcting power factor in an electrical power distribution system comprises a plurality of conventional capacitors 20 electrically connected in series with a plurality of switches 30 both disposed between a line-line voltage in, for example, a three-phase power system 1. For purposes of the present disclosure, a three phase line-line power system will be described and shown in the drawing Figures. However, one of ordinary skill in the art will recognize that the instant invention is capable of being practiced in conjunction with a plurality of one, two and three phase power systems without departing from the teachings herein.

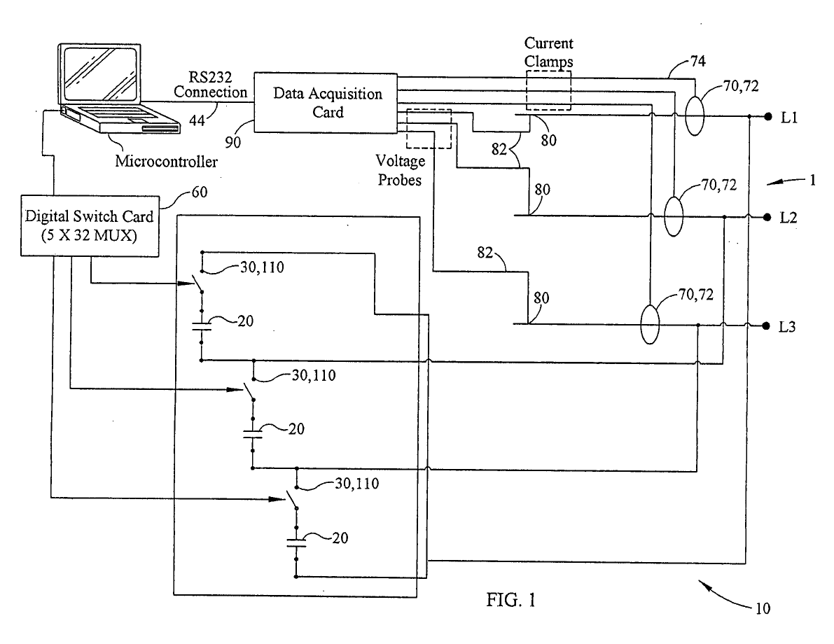

As best seen in FIG. 1, a basic three phase circuit design comprises a single capacitor 20 in series with a switch 30, placed in parallel with a line-line voltage. Switches 30 may be controllable responsive to a signal or signals from a microcontroller 40. Microcontroller 40 may comprise a conventional microprocessor and associated data memory or may be a convention personal computer or industrial automation controller as will be discussed further herein below. Switches 30 may comprise, for example, a plurality of switch contacts that are controlled through activation of a solid state or analog relay that is energized responsive to a signal from microcontroller 40.

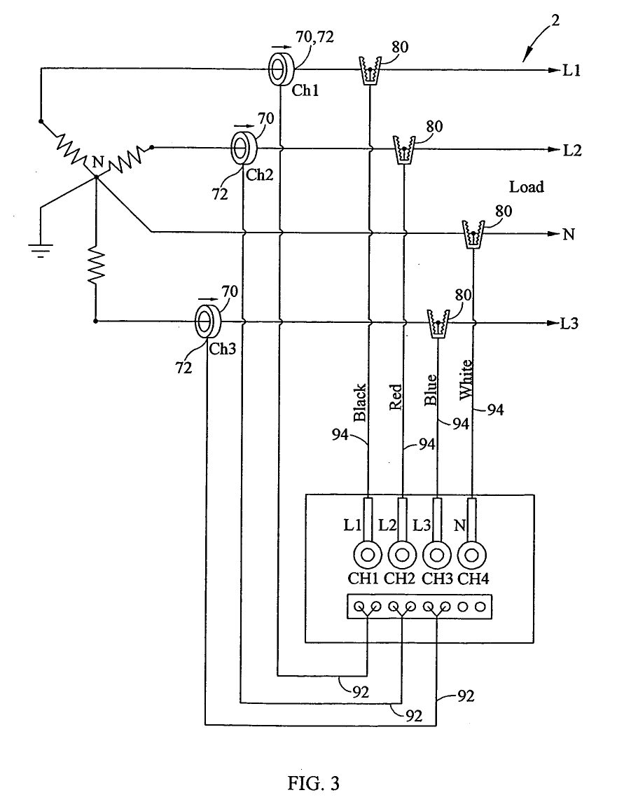

In one embodiment of the present invention 10, the switch 30 used to electrically connect or remove capacitors 20 from between the line-line circuit 1 may be a contact of a high current relay that is controlled by a switching card 42, for example a digital output card controlled by a microcontroller 40. The microcontroller 40 used in the present invention may comprise one of many conventional microprocessors having a concomitant data memory, and provided with suitable programming instructions. Furthermore, the microcontroller 40 may comprises an operator interface 41 or a plurality thereof, for example a keyboard and video screen and mouse. In one embodiment of the invention as shown in FIG. 3, a conventional portable personal computer or laptop computer may be employed as a microcontroller 40. In one embodiment of the present invention, a programmable logic controller may be employed as a microcontroller 40, in conjunction with a plurality of data input and digital and analog input and output cards. Programmable logic controllers are widely commercially available from, for example, the Allen-Bradley® company.

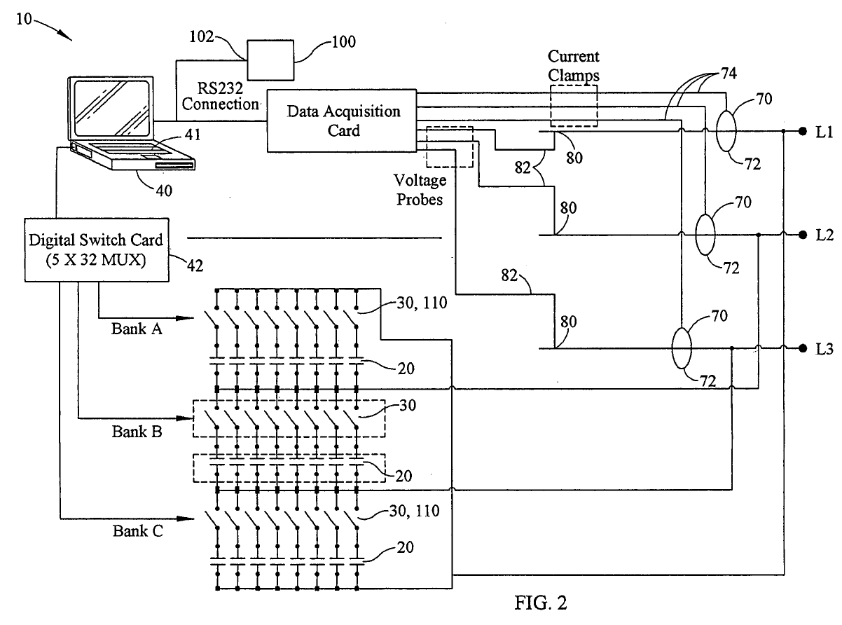

As shown in FIG. 2, a plurality of capacitor-switch (20, 30) pairs having a plurality of capacitance 20 values may be disposed between each line-line circuit, whereby capacitances 20 may be switched into or out of the circuit 1 as required to correct power factor. In the exemplary embodiment shown in FIG. 2, capacitors 20 having values of 5, 10, 20, 30, 40, 50, and 100 var or Kvar may be employed, as required for a given power application. In this embodiment of the invention, three switch banks of high-current relays 50, A, B, and C, respectively, are controlled via a plurality of outputs from a digital switching card 60. Note that a given capacitance is switched into or out of each of the line-line circuits at the same time. That is to say, the switch 30 contacts in switch banks A, B and C for each value of capacitance are ganged together so that the net effect of actuating a switch 30 is an equal capacitance electrically connected between L1, L2 and L3, as required to correct power factor for a given power application.

Additionally, a plurality of current transmitters 70 comprised of a current clamp 72 and output signal 74 representative of the electrical current through a conductor are provided for each of L1, L2 and L3 to determine the current flowing therein, as well as a plurality of voltage probes 80, one each for L1, L2 and L3. Each current transmitter 70 provides a signal 74 representative of current to a data input 42 operatively connected to the microcontroller 40. Similarly, each voltage probe 80 provides an output signal 82 representative of voltage on the line to a data input 42 as well. By providing the current and voltage values in each leg of the power system circuit power factor may be readily computed in the microcontroller 40 by simply determining the ratio of active to apparent power.

Accordingly, assuming a lagging power factor inherent in inductive loads, where the power factor remains below one, the microcontroller 40 begins adding capacitance 20 between all three phases of the power system, beginning with the smallest available capacitance, and advancing to larger values as necessary. The microcontroller 40 accomplishes this by calculating the power factor from the current and voltage data input from the data inputs 42 card after each successive capacitance is switched into the circuit, then comparing the calculated power factor value to unity. If the power factor is not yet within a predetermined threshold value of unity, additional capacitance 20 is switched into the circuit and the process iterates. In one embodiment of the present invention a conventional power factor meter may be employed in place of current transmitters 70 and voltage probes 80 to measure power factor. In this embodiment the power factor meter provides a data input 42 representative of power factor to microprocessor 40. As one example, a minimum acceptable power factor correction would be 90% power factor, while an exemplary correction would be 98%.

Once the calculated power factor value is within a predetermined threshold of unity the microcontroller 40 notes how much capacitance 20 has been electrically connected line-line in the power system by simply determining which switches 30 have been closed, thence adding capacitances 20 corresponding to the closed switches 30. This power factor correction capacitance value C_{pf} is then stored in data memory in the microcontroller 40, such that a user or operator may recall this value to specify the requisite capacitance 20 to be placed line-line in each leg of that power circuit 1 for power factor correction. A plurality of switching methodologies or schemes may be employed with the system of the present invention in order to attain near unity power factor so long as the necessary power factor correction value C_{pf} is calculated.

The capacitance 20 required to correct power factor will differ greatly from application to application depending upon the electrical characteristics of each circuit. In other words, proper power factor correction requires carefully sizing the required capacitance 20 for the system to attain, as near as possible, unity power factor. Various devices are known in the art for determining the inductance of a given load and matching the necessary capacitance 20. In one embodiment of the present invention a power factor meter 100 having an output 102 representative of power factor electrically connected to a microcontroller 40 via, for example, and RS232 connection 44 may be employed in place of the current transmitters 70 and voltage probes 80 described herein above. In this embodiment, the microcontroller 40 simply calculates the required power factor correction value C_{pf} based on the measured power factor and line voltage of the power system.

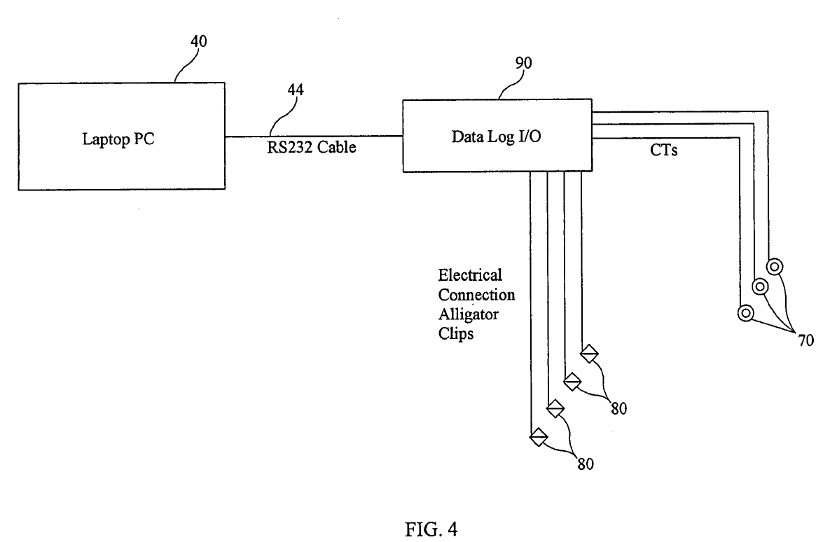

In a further embodiment of the invention as shown in FIGS. 3 and 4 microcontroller 40 comprises a laptop personal computer having a conventional RS232 communication connection 44 with an data card 90 comprising a plurality of inputs 92 electrically connected to current transmitters 70 and voltage probes 80. The current and voltage data collected by data card 90 is transmitted back to microcontroller 40 via the RS 232 cable for power factor calculations. FIG. 3 depicts a conventional 4 wire wye power system 2 connected to data card 90 wherein current transmitters 70 are each connected to three separate input channels 92 and voltage probes 80 are connected to voltage inputs 94. The voltage and amperage data transmitted to the microcontroller may then be used to calculate the power factor by the following formula: Power Factor PF=Power (Watts)/Current (I)*Voltage (V).

It will be appreciated that if the inductive load changes in the circuit being used, the present invention will readily re-calculate the capacitance 20 required to correct the power factor in the system. In this embodiment of the system, the power factor correction circuit is actually active in that the capacitance will change along with changing load inductance which may occur when additional inductive loads are added to a system.

In a yet further embodiment of the present invention, a system 10 may be permanently installed in a given power application where an electrical load may have an inductance that varies over time. In this embodiment of system 10 microcontroller 40 capacitors 20, switches 30, and a digital switch card 60 if necessary, are integrated into a single compact and portable unit 10 that may be installed in an electrical enclosure proximate the connection points to the power conductors L1, L2, and L3. The current transmitters 70 and voltage probes 80 are then electrically connected to the power conductors L1, L2, and L3 to provide a system that continuously adjusts the capacitance between phases to achieve a power factor within a predetermined value of unity.

In a yet further embodiment of the present invention the portable power factor correction apparatus described herein above may be utilized in an industrial setting to monitor and calculate power factor for a plurality of electrical loads such as various motors employed in a modern manufacturing facility. This embodiment of the apparatus 10 may be operated by an electrician, engineer, or suitably trained technician to analyze the operating power factor for a plurality of electrical loads whereupon an appropriate power factor correction capacitance C_{pf} may be assigned to each in turn.

In another embodiment of the present invention, the switches 30 may comprise a plurality of high current breakers 110 that are electrically sized to protect the wiring of the present invention from excessive current flowing in the power system. Furthermore, the switches 30 or breakers 110 may simply be controlled manually by actuating the switches by hand, thence noting the power factor associated with a given amount of capacitance in the circuit. Where the switches are manually operated, it is preferable to have switches 30 corresponding to a given capacitance 20 in parallel with each pair of phases of the power system mechanically ganged together so that the capacitance 20 is switched into or out of the circuit simultaneously.

The component parts of the power factor correction apparatus 10 described herein can be contained in a relatively compact portable package such that the apparatus may be readily transported to various locations to enable a user to accomplish power factor correction at remote sites. As an example, a laptop computer 40 may be mounted in a compact case with a data card 90 such that the current transmitters 70 and voltage probes 90 extend from the case via a plurality of leads for connection to a motor or equivalent load. The feature of the invention permits ease of operation for technicians, since all the tools required to analyze the power factor of a motor are contained in portable case. Furthermore, where a laptop computer is utilized as microcontroller 40, suitable programming instructions may be provided thereto to provide a convenient user interface template for a technician to enter the requisite motor data and take the necessary voltage and current readings.

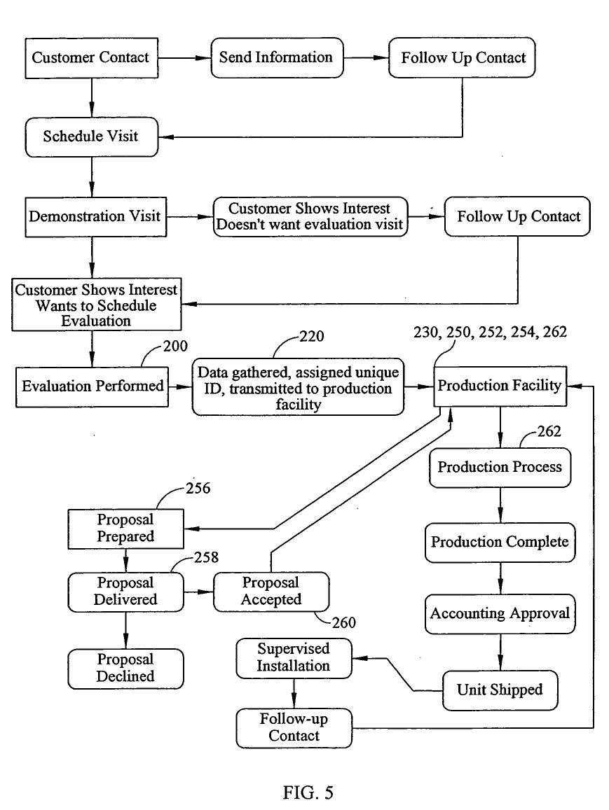

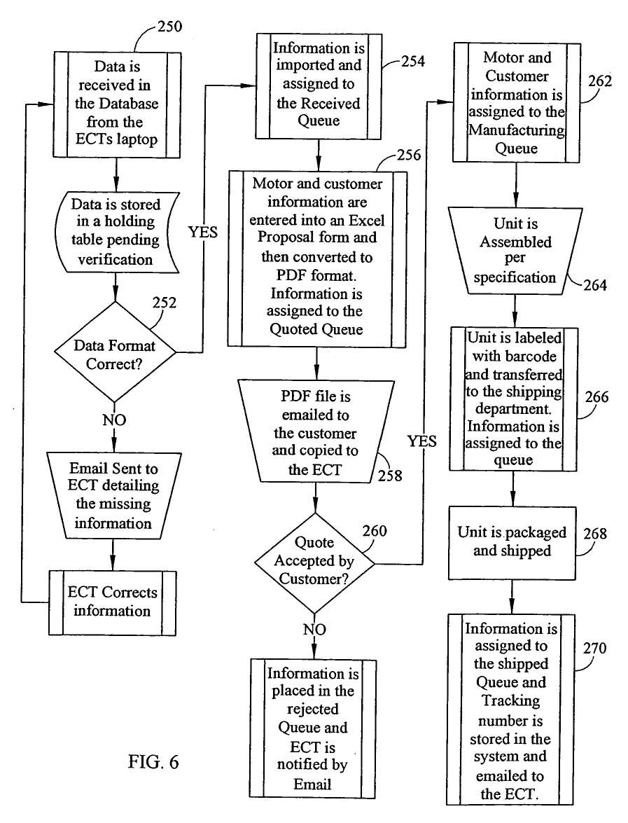

Referring now to drawing FIGS. 5 and 6 a system and method is depicted of evaluating an electrical power system 1 at a specific facility with its attendant inductive loads, and specifying a power factor correction capacitance, or a plurality thereof, to be assembled, shipped and installed at the facility. Once a customer decides to analyze the power factors of the various motors at its facility an evaluation 200 is performed wherein the apparatus 10 for determining power factor correction is secured to the motor leads (power wiring) of each inductive load to be analyzed in the facility.

For each load analyzed the technician connects the current transmitters 70 and voltage probes 80 to the load whereupon microcontroller 40 records the current and voltage data therefrom. Alternatively, the power factor may be measured by a suitable power factor meter 100 as discussed herein above. Once power factor is calculated or measured, microcontroller 40 calculates a corrective capacitance value C_{pf} required to correct for the power factor measured or calculated for that load. This corrective value is then stored in a data file 220 and assigned a unique identifier code. Furthermore, data representative of features of the inductive load may also be stored in data file 200 with the concomitant corrective capacitance value C_{pf}. For example, if the load is a motor, a technician conducting the evaluation can enter data using the operator interface 41 (or laptop computer) including but not limited to motor type, size, horsepower, amperage, physical locations, disconnect size and location, MCC location, facility operational characteristics etc. This information can be included to enable a technician to quickly locate the motor once a power factor correction capacitance is ready to be installed.

The unique identifier assigned to each load-capacitance value may be any numerical or alphanumeric code or may also include information related to the load characteristics and corrective capacitance value C_{pf} as discussed herein above. The unique identifier may also be printed on label, tag or other similar visible indicia thence affixed to the associated motor or load to facilitate matching the load with its corrective capacitance C_{pf} for installation. The unique identifier and the information associated with it may also be encoded in, for example, a bar code format to permit the data contained therein to be quickly obtained by use of a bar code scanner or the like. Furthermore, the unique identifier may be any format as long as it comprises data sufficient to identify the load and the corrective capacitance value C_{pf} associated therewith.

Once each load in an individual facility has been evaluated the unique identification codes associated with each load in the facility (and their concomitant data) are transmitted to a production facility 220, 230, as shown in FIGS. 5 and 6. The transmission of the unique identification codes may be via wireless communications protocol or any other electronic transmission format, such as e-mail.

At the production facility a cost proposal may be prepared utilizing the data included in the unique identification codes. Once the proposal or quote is accepted by a customer, the production process is initiated. In one embodiment of the invention as shown in FIG. 6 the data included with each unique identification code is input to a database 250 whereupon its format is verified 252 and the data is assigned to a received queue 254. Once in the received queue 254 the data are imported into a spreadsheet format, for example and Excel® spreadsheet, that includes cost data based upon the data for each load or motor. This proposal form is then converted to a .pdf file format, or any file type that is not readily modified and that minimizes the risks associated with the presence of meta data, and then transmitted to the customer 258 for their approval. A copy of this information is also stored in a quoted queue 256.

Once the quote or proposal is accepted by the customer 260 the data associated with each motor is assigned to a manufacturing queue 262 where each individual power factor correction capacitance is installed 264 into a suitable electrical enclosure for installation in the facility. As an example, where the facility has operational characteristics that include high dust concentrations or the like, it may be necessary to install the corrective capacitance in an explosion proof enclosure, or one having a suitable NEMA rating for explosive environments. Furthermore, a label having the unique identification code and data associated therewith 266 is printed and affixed to the enclosure so that the appropriate power factor correction device can be readily matched with its corresponding motor in the field.

Each apparatus is then packaged and shipped to the customer 268 and the evaluating technician is notified 270 that the customer has been shipped the necessary equipment for installation. The aforementioned processing steps 250, 252, 254, 256, 258, 260, 262 and 270 may be performed utilizing a convention personal computer having an associated memory and suitable programming instructions.

The foregoing detailed description of the embodiments of the invention is presented primarily for clearness of understanding and no unnecessary limitations are to be understood or implied therefrom. Modifications to the present invention in its various embodiments will become obvious to those skilled in the art upon reading this disclosure and may be made without departing from scope of the invention encompassed by the claims appended hereto.

I claim:

1. An apparatus for determining the necessary capacitance required to correct power factor in an electrical power system having at least one line to line voltage comprising:
a plurality of capacitors having predetermined capacitances connected in series with a plurality of switching devices, said capacitances and switching devices connected between the line voltages of said power system to correct power factor; and
a means for determining power factor in said power system, whereby said plurality of capacitances are connected between said line voltages of said power system by closing said switching devices until the power factor in said system approaches unity.

2. An apparatus as claimed in claim 1 wherein the value of said capacitances is matched to a corresponding inductive load to provide a power factor near unity as measured by said means for measuring power factor.

3. An apparatus as claimed in claim 2 wherein the value of said capacitances is adjusted by adding or subtracting capacitance between the line voltages of said power system.

4. An apparatus as claimed in claim 1 wherein said switching devices comprise a plurality of relay contacts.

5. An apparatus as claimed in claim 1 wherein said switching devices comprise a plurality of high-current breakers.

6. A system as claimed in claim 1 further comprising:
a microcontroller having a data acquisition card for accepting data representative of power factor from said means for measuring power factor; and
a means for opening and closing said switching devices responsive to said data representative of power factor.

7. A system as claimed in claim 6 wherein the value of each of said capacitances is matched to a corresponding inductive load to provide a power factor for the system that approximates unity.

8. A system as claimed in claim 6 wherein the value of each of said capacitances is adjusted by adding or subtracting capacitance between the phases of said power system by closing or opening said switching devices.

9. A system as claimed in claim 6 wherein said means for opening and closing said switching devices responsive to said data representative of power factor comprises a digital relay card responsive to an output from said microcontroller.

10. A system as claimed in claim 6 wherein said means for opening and closing said switching devices responsive to said data representative of power factor comprises a digital output card responsive to an output from said microcontroller, said digital output card electrically connected to a plurality of high current relays.

11. A system as claimed in claim 1 wherein said means for determining power factor is a power factor meter.

12. A system as claimed in claim 1 wherein said means for determining power factor is a plurality of current transmitters having outputs representative of current and a plurality of voltage probes having outputs representative of voltage.

13. A method of providing a power factor correction capacitance for a specified load comprising the steps of:
a.) determining the power factor at said load;
b.) calculating a corrective capacitance value required to correct the power factor at said load to a predetermined value;
c.) assigning a unique identifier code to said load comprising load data and corrective capacitance value data;
d.) transmitting said unique identifier to a production facility;
e.) assembling a power factor correction capacitance using the corrective capacitance data for said load; and
f.) providing said unique identifier code on a label secured to said power factor correction capacitance.

14. A method of providing a power factor correction capacitance for a specified load as claimed in claim 13 comprising the further step of:
g.) providing said unique identifier code on a label to be secured on or proximate to said load whereby said power factor correction capacitance and said load are readily matched by matching their respective labels.

15. A method of providing a power factor correction capacitance for a specified load as claimed in claim 13 wherein said unique identifier code is a bar code.

16. A method of providing a power factor correction capacitance for a specified load as claimed in claim 13 comprising the further step of:
h.) electrically connecting said power factor correction capacitance to said load.

17. A method of providing a power factor correction capacitance for a specified load as claimed in claim 13 wherein the step of transmitting said unique identifier to a production facility is accomplished via wireless data communication.

18. A method of providing a power factor correction apparatus for a specified load as claimed in claim 13 wherein said unique identifier code further comprises customer identification data.
